(19) United States
(12) Patent Application Publication
(10) Pub. No.: US 2008/0303444 A1
(43) Pub. Date: Dec. 11, 2008

(54) LED LIGHTING MODULE WITH RADIATING AND AUTOMATIC POWER-OFF FUNCTIONS

(75) Inventors: Te-Chang Chou, Hukou Township (TW); Ming-Cyuan Shih, Jhubei City (TW)

Correspondence Address: EGBERT LAW OFFICES, 412 MAIN STREET, 7TH FLOOR, HOUSTON, TX, 77002, US

(73) Assignee: FORCECON TECHNOLOGY Co., Ltd., Chu Pei City (TW)

(21) Appl. No.: 11/761,286

(22) Filed: Jun. 11, 2007

(51) Int. Cl. H01J 7/24; H05B 37/02

(52) U.S. Cl. 315/32; 315/307

(57) ABSTRACT

The present invention provides an LED lighting module with radiating and automatic power-off functions. The module includes a power supply element, an LED element and radiating member as well as a circuit linking them. The circuit linking the power supply element, LED element and radiating member is a serial loop, so that the power supply element, LED element and radiating member are combined into a single loop circuit. The LED elements will be automatically turned off if the radiating member is burnt to prevent the overheating problem of LED elements and to prolong the service life with improved applicability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to an LED lighting module, and more particularly to an innovative module which is available with radiating and automatic power-off functions.

2. Description of Related Art Including Information Disclosed Under 37 CFR 1.97 and 37 CFR 1.98

As compared with traditional lamps, LED lighting modules are widely applied to various lighting devices and LEDs, thanks to improved electricity consumption and longer service life. Once activated, LED lighting modules generate heat with the passage of time. LED will be damaged if the heat exceeds a predefined value. For this reason, LED lighting modules are generally fitted with a radiator fan.

The LED lighting module to be improved is shown in FIGS. 1 and 2, wherein a parallel circuit 13 is provided between the radiator fan 11 and fuel cell 12 of LED lighting module 10. The same case is shown in another parallel circuit 15 between LED 14 and fuel cell 12. There are the following shortcomings for the circuit found in actual applications.

For example, in a case when the radiator fan 11 is burnt out when the LED lighting module 10 operates, LED 14 will be highlighted continuously due to another circuit 15 between LED 14 and fuel cell 12. In such a case, the temperature of LED 14 will rise quickly. The user cannot find out the potential risk since LED 14 is always highlighted, leading to burnout of LED 14. Moreover, overheating of LED 14 will lead to quicker degrading of components and shorter service life of lighting modules.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

Based upon innovation, the power supply element, LED element and radiating member are linked into a serial loop circuit. LED elements will be automatically turned off if the radiating member is burnt. This aids to resolve and prevent the overheating problem of LED elements mentioned in the prior art, thus prolonging the service life of LED lighting modules with improved applicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a schematic view of a circuit diagram of a typical LED lighting module.

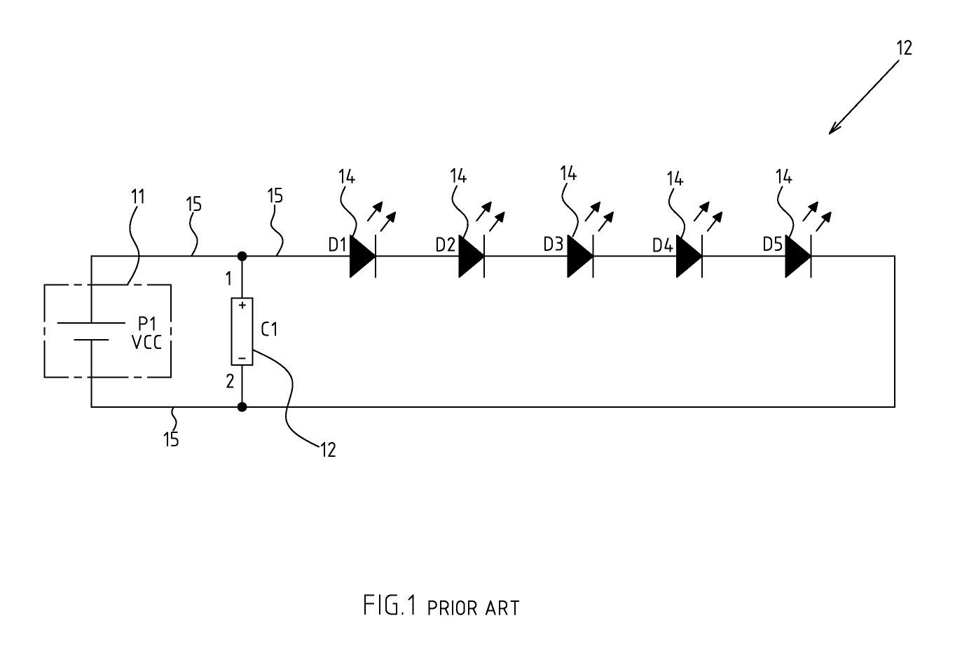

FIG. 2 shows another schematic view of a typical LED lighting module.

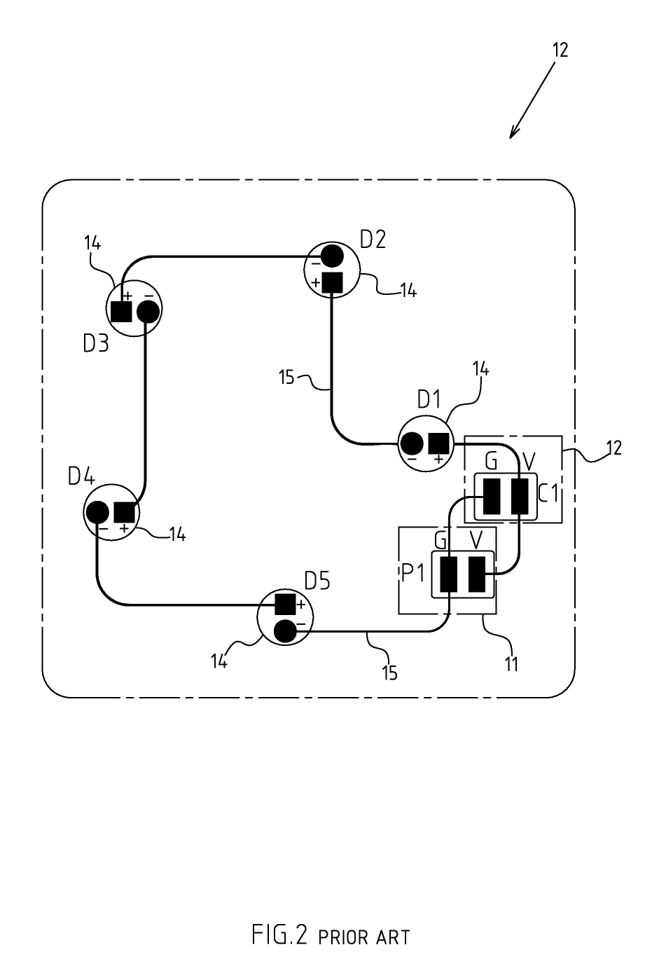

FIG. 3 shows a schematic view of a circuit diagram of the LED lighting module of the present invention.

FIG. 4 shows another schematic view of the LED lighting module of the present invention.

FIG. 5 shows a schematic view of the structure of the LED lighting module of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

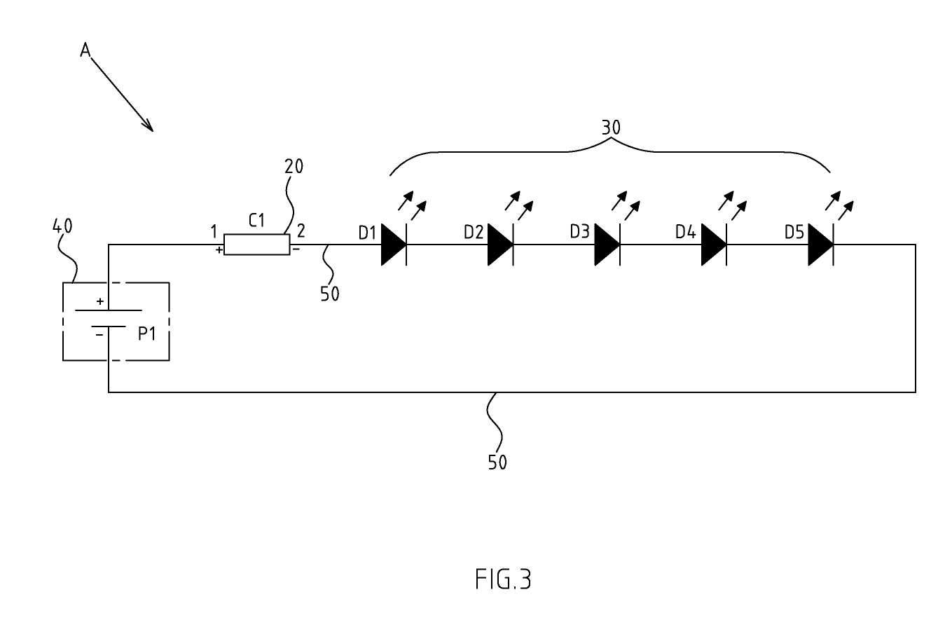

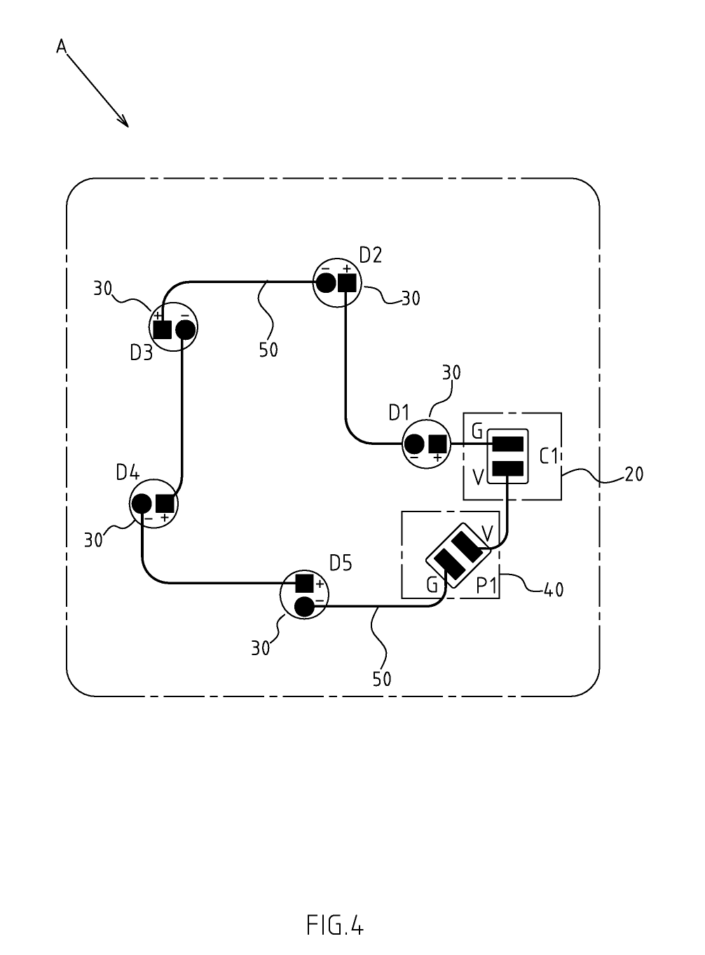

FIGS. 3-5 depict preferred embodiments of the LED of the present invention with radiating and automatic power-off functions. The embodiments are provided only for explanatory purposes. The LED lighting module comprises a power supply element 20, LED element 30, radiating member 40 and a circuit 50 linking the power supply element 20, LED element 30 and radiating member 40.

The core design of the present invention lies in the circuit 50 linking the power supply element 20, LED element 30 and radiating member 40 in a serial loop. Thus, the power supply element 20, LED element 30 and radiating member 40 are combined into a single loop circuit. The preferred embodiment of the circuit is depicted in FIG. 3, wherein the negative terminal circuit 50 of the power supply element 20 is linked to one terminal of LED element 30, and positive terminal circuit 50 linked to positive terminal of radiating member 40. The negative terminal of the radiating member 40 is linked to the other terminal of LED element 30, so the entire circuit 50 is integrated into a single loop circuit. When the LED lighting module is activated, LED element 30 and radiating member 40 may be operated synchronously. In a case when the radiating member 40 is burnt out, the single loop circuit 50 will be cut off, leading to break-up of positive terminal circuit 50 and LED element 30 of the power supply element 20. In such a case, the power of LED element will be turned off to avoid overheating damage.

In case when any LED of the LED element is burnt in the serial loop circuit 50, other LEDs of the LED element and the radiating member 40 will be turned off, enabling the operator to learn the real-time information for immediate maintenance.

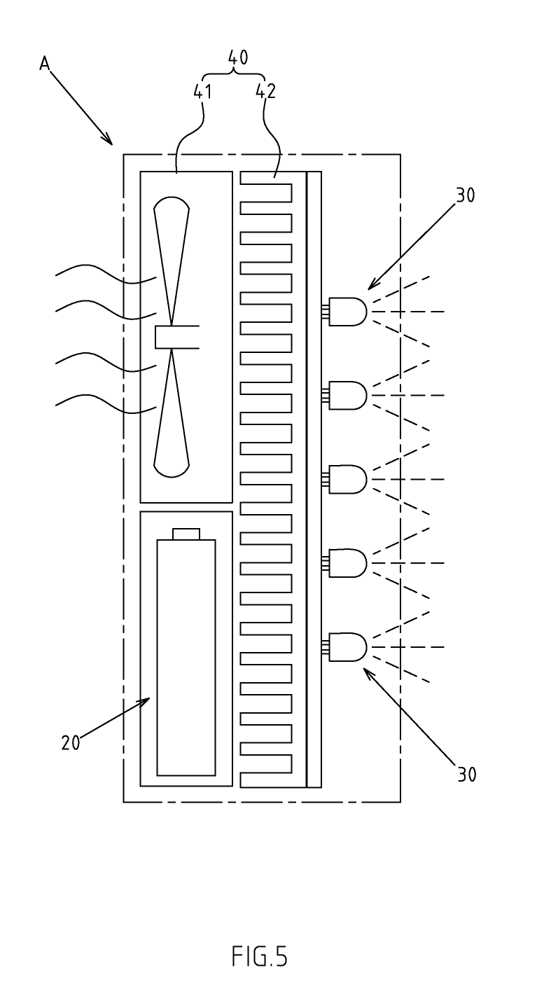

The radiating member may be a fan. Alternatively, referring to FIG. 5, the radiating member 40 may be composed of a fan 41 and some radiating fins 42. The radiating fins 42 are linked to LED element 30 to diffuse the heat generated by LED element 30 and to improve the radiating effect.

1-3. (canceled)

4. A lighting module comprising:
a power supply element;
an LED element; and
a radiating member connected to said power supply element and said LED element by a single serial loop circuit such that when said radiating member fails the LED element receives no power from said power supply element, said radiating member being a fan.

5. The lighting module of claim 4, said radiating member having a plurality of radiating fins, said plurality of radiating fins directed toward said LED element so as to pass air from said fan toward said LED element so as to diffuse heat therefrom.
